(19) United States
(12) Patent Application Publication
(10) Pub. No.: US 2019/0284460 A1
(43) Pub. Date: Sep. 19, 2019

(54) PARTICULATE MATERIAL AND METHOD FOR FORMING SAME

(71) Applicant: Saint-Gobain Ceramics & Plastics, Inc., Worcester, MA (US)

(72) Inventors: Tihana FUSS-DEZELIC, Stow, OH (US); Jingyu Shi, Hudson, OH (US); Jennifer H. Czerepinski, Framingham, MA (US); Wesley S. Towle, North Grosvenordale, CT (US); Ian Kidd, Worcester, MA (US)

(21) Appl. No.: 16/352,752

(22) Filed: Mar. 13, 2019

Related U.S. Application Data
(60) Provisional application No. 62/642,591, filed on Mar. 13, 2018.

(51) Int. Cl. C09K 3/14; B24C 9/00

(52) U.S. Cl. CPC C09K 3/1409; B24C 9/006

(57) ABSTRACT

A plurality of particles of abrasive particles, wherein at least 1% of the abrasive particles of the plurality of abrasive particles can have a first shape, wherein the first shape includes a body including a first surface having a rounded contour, a second surface joined to the first surface at a first edge, the second surface having a less rounded contour than the first surface, and a third surface joined to the first surface at a second edge, the third surface having a less rounded contour than the first surface. The plurality of particles can further comprise an average particle size of at least 300 microns and not greater than 900 microns, a specific surface area of at least 0.04 m²/g and not greater than 0.10 m²/g, and an alumina content of at least 65 wt % based on a total weight of the plurality of particles.

### CROSS-REFERENCE TO RELATED APPLICATION

This Application claims priority under 35 U.S.C. § 119(e) to U.S. Provisional Application No. 62/642,591, entitled “PARTICULATE MATERIAL AND METHOD FOR FORMING SAME,” by Tihana FUSS-DEZELIC, et al., filed Mar. 13, 2018, which is assigned to the current assignee hereof and is incorporated herein by reference in its entirety.

### BACKGROUND

### Field of the Disclosure

The following is directed to particulate material.

### Description of the Related Art

The industry continues to demand improved abrasive particles and abrasive tools incorporating abrasive particles.

### BRIEF DESCRIPTION OF THE DRAWINGS

The present disclosure may be better understood, and its numerous features and advantages made apparent to those skilled in the art by referencing the accompanying drawings.

FIG. 1A includes a perspective view illustration of an abrasive particle according to an embodiment.

FIG. 1B includes top-down view illustration of the abrasive particle of FIG. 1A.

FIG. 1C includes a cross-sectional illustration of the abrasive particle of FIG. 1A.

FIG. 1D includes a top-down view illustration of an abrasive particle according to an embodiment.

FIG. 1E includes a cross-sectional view of the abrasive particle of FIG. 1D.

FIG. 1F includes a perspective view illustration of an abrasive particle according to an embodiment.

FIGS. 2-5 include images of pluralities of abrasive particles according to embodiments herein.

FIG. 6A includes an image of a plurality of round proppant particles.

FIG. 6B includes an image of plurality of abrasive particles according to an embodiment.

FIG. 6C includes an image of a plurality of angular abrasive particles.

FIG. 7A includes an image of a plurality of abrasive particles according to an embodiment.

FIG. 7B includes an image of a plurality of angular abrasive particles.

FIG. 7C includes an image of a plurality of brown fused alumina particles.

FIG. 8 includes a graph illustrating friability measurements of abrasive particles of the present disclosure in comparison to the friability of brown fused alumina particles.

FIG. 9 includes a graph comparing the grinding performance of single layer wheels containing abrasive particles of the present disclosure in comparison to single layer wheels made with other types of abrasive particles.

FIG. 10 includes an image of a plurality of abrasive particles according to one embodiment.

FIG. 11 includes a graph illustrating the percent amount of particles having the shape of a spherical wedge in batches of abrasive particles of varying particle size according to embodiments.

FIG. 12 includes a graph illustrating the sphericity value of batches with different particle size according to embodiments, and comparing the sphericity value with batches of other types of particles.

FIG. 13A includes an image of a plurality of abrasive particles obtained by roller crushing according to one embodiment.

FIG. 13B includes an image of a plurality of abrasive particles obtained by high impact crushing.

### DETAILED DESCRIPTION

The following description in combination with the figures is provided to assist in understanding the teachings provided herein. The following disclosure will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

Embodiments disclosed herein are directed to a plurality abrasive particles including particles of a specific shape. The plurality of abrasive particles can have a high strength and excellent grinding performance if integrated in an abrasive article, is very suitable for blasting, and can be manufactured in a cost efficient way.

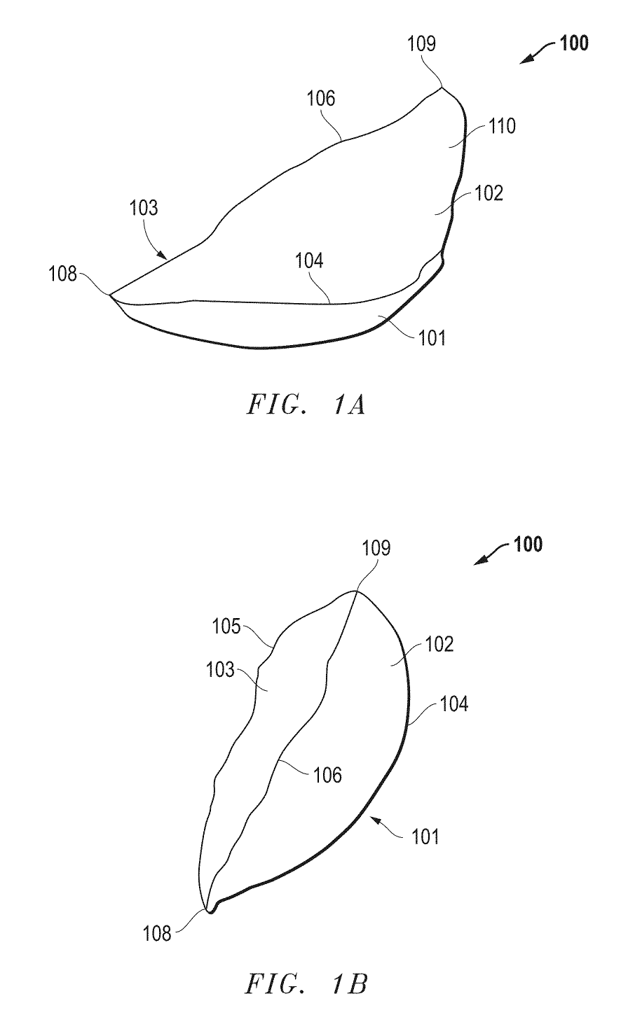

FIGS. 1A-1C include illustrations of an abrasive particle having a body having a first shape according to an embodiment. The first shape can have any of the features as claimed herein. The abrasive particle 100 can include a body 110 having a first surface 101, a second surface 102, a third surface 103, a first edge 104, a second edge 105, and a third edge 106. Such features can have any of the features as described in the claims herein. The body further includes a first exterior corner 108 and a second exterior corner 109. The body can further include a central angle 190 having any of the features of the embodiments herein. For a single particle, the central angle can be measured and calculated as an average based on a suitable number of randomly sampled locations along the length of the third edge 106. Any of the quantified features of the embodiments herein can be average values taken for a suitable number of randomly selected measurements within a particle or within a group of particles depending upon whether the feature is relevant to a single particle or a plurality of particles. For example, for a feature of a single particle, a suitable number of measurements (randomly selected) are made to determine an average value for the feature within a particle. For a feature associated with a plurality of particles, a suitable number of measurements (randomly selected) are made across the plurality of particle to calculate the average value of the feature for the plurality of particles.

FIGS. 1D and 1E include illustrations of an abrasive particle having a body having a first surface 101, a second surface 102, a third surface 103, a first edge 104, and a second edge 105 and any of the claim features associated with such elements. The body of FIG. 1D and FIG. 1E further includes a fourth surface 111, a third edge 112 and a fourth edge 113 and any of the claim features associated with such elements.

FIG. 1F includes an illustration of an abrasive particle having a body including a first surface 101, a second surface 102, a third surface 103, a first edge 104, and a second edge (not illustrated) and a third edge 106 and any of the claim features associated with such elements. The abrasive particle of FIG. 1F further includes a fractured corner region 131 and any of the claim features associated with such an element.

In one aspect, the first edge 104 can have a substantially curved contour. In another aspect, the second edge 105 can have a substantially curved contour. The curved contour can be irregular or regular. In another aspect, the second surface 102 and the first surface 102 can be joined at a third edge 112, wherein the third edge 112 can have a substantially linear contour.

In one aspect, the second surface 102 and third surface 103 can be angled with respect to each other and define a central angle less than 180 degrees, or less than 170 degrees, or less than 160 degrees, or less than 150 degrees, or less than 140 degrees, or less than 130 degrees, or less than 120 degrees, or less than 110 degrees, or less than 100 degrees, or less than 90 degrees, or less than 80 degrees, or less than 70 degrees, or less than 60 degrees, or less than 50 degrees, or less than 40 degrees, or less than 30 degrees. In another aspect, the central angle can be at least 1 degree, or at least 10 degrees, or at least 20 degrees, or at least 30 degrees, or at least 40 degrees, or at least 50 degrees, or at least 60 degrees, or at least 70 degrees.

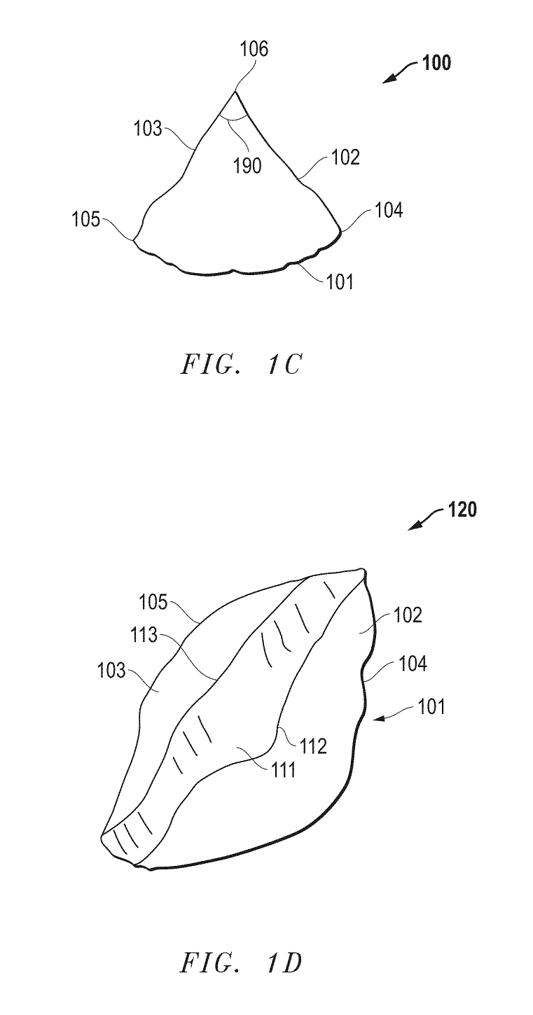

FIG. 2 includes an image of a plurality of abrasive particles according to an embodiment. As depicted, the abrasive particles 201 approximate the shape of a sphere sector or a spherical wedge (similar like the shape of an orange slice), such that the abrasive particles 201 appear to have been part of a sphere prior to comminution. The abrasive particles 201 can have fractured surfaces and surfaces that are more rounded as evidence that such particles were previously part of a sphere shape prior to crushing of the solid spheres.

In one embodiment, a method for forming the plurality of abrasive particles of the present disclosure can comprising: comminuting a plurality of sintered particles, wherein at least a portion of the sintered particles can have a solid spherical shape prior to comminuting.

In a particular embodiment, the sintered particles subjected to comminuting can be proppant particles having a high sphericity. As used herein, the terms round shape, spherical shape, and spherical wedge do not necessarily relate to perfectly round particles, but the overall impression makes them look round or roundish, or having sections of a certain roundness.

In one embodiment, the plurality of abrasive particles of the present disclosure can be made by comminuting sintered proppant particles comprising as a majority alumina. As used herein, if referring to the material of the plurality of particles, each particle of the plurality of particles can contain the same material. In a particulate embodiment, the aluminous material can comprise bauxite.

In a certain embodiment, a method of the forming the plurality of abrasive particles of the present disclosure can comprise: forming a green granule mixture comprising an inorganic material, an organic binder and water, wherein the inorganic material can comprises alumina in an amount of at least 60 wt % based on a total amount of the inorganic material. The green granule mixture can be sintered at a temperature of at least 1100° C. to form proppant particles having a round shape. After sintering, the proppant can be subjected to comminuting, also described herein as crushing.

It has been surprisingly discovered that the type of crushing treatment of the round proppant particles can lead to a plurality of particles including to a larger extent particles having the shape of a spherical wedge, as shown in FIGS. 1A-1F.

In one particular embodiment, as further described in the examples, the crushing can be conducted using a roller crusher. Other crushing treatments, e.g., high impact crushing with a pin wheel crusher, did not lead to the forming of particles having the shape of a spherical wedge.

The plurality of abrasive particles of the present disclosure can further have a combination of properties, such as specific surface area, average particle size, loose packed density, and a high amount of alumina, which can provide a high resistance towards breakage under stress, herein also described as having a low friability. As used herein, friability is expressed as the percentage of particle size loss under stress. Accordingly, the lower the friability of a particle batch, the stronger are the particles against breakage under stress. As further shown in the examples, the friability of the plurality of abrasive particles of the present disclosure, measured as ball mill friability and high pulse oscillation friability, can be lower than the friability of brown fused alumina (BFA) particles, which are known for being used as abrasive particles in a multitude types of abrasive articles.

In one embodiment, the ball mill friability (BM-F) of the plurality of particles can be not greater than 50%, such as not greater than 45%, not greater than 40%, or not greater than 35%, the BM-F being the percentage loss of 100 g particles having an average size between 500 microns and 600 microns, and subjected to 8.0 minutes ball milling with a US Stoneware ball mill machine at 78-80 rpm.

In another embodiment, the high pulse oscillation friability (HPO-F) of the plurality of particles can be not greater than 85%, such as not greater than 80%, not greater than 75%, not greater than 70%, or not greater than 68%, the HPO-F being measured with 25 g of the plurality of particles having an average particle size between 500 microns and 600 microns with a high pulse oscillation crusher at 1450 rpm for 5 seconds, and wherein the HPO-F expresses a percentage of particle breakdown to a size lower than 425 microns.

In one aspect, the specific surface area of the plurality of abrasive particles of the present disclosure can be at least 0.045 m²/g, or at least 0.050 m²/g, or at least 0.055 m²/g. In another aspect, the specific surface area can be not greater than 0.095 m²/g, or not greater than 0.090 m²/g, or not greater than 0.085 m²/g. The specific surface area can be a value between any of the minimum and maximum values noted above.

In another aspect, the alumina content of the plurality of particles can be at least 65 wt %, or at least 67 wt %, or at least 70 wt %, or at least 72 wt %, at least 75 wt %, or at least 80 wt % based on the total weight of the plurality of particles.

In a certain aspect, the average particle size of the plurality of abrasive particles can be at least 100 microns, or at least 200 microns, or at least 250 microns, or at least 300 microns, or at least 350 microns, or at least 400 microns, or at least 450 microns, or at least 500 microns. In another certain aspect, the average size (D50) of the plurality of particles may be not greater than 1000 microns, such as not greater than 900 microns, not greater than 800 microns, not greater than 750 microns, not greater than 700 microns, or not greater than 650 microns, or not greater than 600 microns. The average size of the plurality of particles can be a size within any of the minimum and maximum values noted above.

In a further aspect, the loose pack density (LPD) of abrasive particles measured according to ANSI B74.4-1992 can be not greater than 1.9 g/cm³, such as not greater than 1.85 g/cm³, not greater than 1.80 g/cm³, not greater than 1.75 g/cm³, or not greater than 1.70 g/cm³. In another aspect, the LPD may be not greater than 1.9 g/cm³, such as not greater than 1.85 g/cm³, not greater than 1.80 g/cm³, not greater than 1.75 g/cm³, or not greater than 1.70 g/cm³. The LPD of the abrasive particles may be a value between any of the minimum and maximum values noted above.

In a particular embodiment, the plurality of abrasive particles of the present disclosure can have an average particle size of at least 300 microns and not greater than 900 microns, a specific surface area of at least 0.04 m²/g and not greater than 0.10 m²/g, a loose packed density (LPD) of at least 1.50 g/cm³ and not greater than 2.0 g/cm³, and an alumina content of at least 63 wt % based on a total weight of the plurality of particles.

As described above, the plurality of abrasive particles of the present disclosure can comprise particles have the shape of a spherical wedge. In one embodiment, the percent amount of particles having the shape of a spherical wedge based on the total number of the plurality of abrasive particles can be at least 1%, such as at least 5%, at lest 10%, at least 15%, at least 20%, at least 25%, at least 30%, at leas 35%, at least 40%, at least 45%, or at least 50%. In a particular embodiment, the percent amount of abrasive particles having the shape of a spherical wedge can be at least 10% and not greater than 50%.

As used herein, grit, mesh, and sieve sizes mentioned in the present disclosure relate to definitions of ANSI B74.12-2001, unless stated or described otherwise.

As further demonstrated in the Examples, it could have been surprisingly shown that the plurality of particles of the present disclosure can have a lower friability than brown fused alumina (BFA) particles, and the grinding performance was comparable to the performance of BFA particles.

### Embodiments

Embodiment 1. An abrasive particle including a body including a first surface having a rounded contour, a second surface joined to the first surface at a first edge, the second surface having a less rounded contour than the first surface, and a third surface joined to the first surface at a second edge, the third surface having a less rounded contour than the first surface.

Embodiment 2. The abrasive particle of Embodiment 1, wherein the first edge defines a substantially curved contour.

Embodiment 3. The abrasive particle of Embodiment 1, wherein the second edge defines a substantially curved contour.

Embodiment 4. The abrasive particle of Embodiment 1, wherein the first edge comprises an irregular and curved contour.

Embodiment 5. The abrasive particle of Embodiment 1, wherein the second edge comprises an irregular and curved contour.

Embodiment 6. The abrasive particle of Embodiment 1, wherein the second surface and first surface are joined at a third edge, the third edge having a substantially linear contour.

Embodiment 7. The abrasive particle of Embodiment 1, wherein the second surface and third surface are angled with respect to each other and define a central angle less than 180 degrees, or less than 170 degrees, or less than 160 degrees or less than 150 degrees or less than 140 degrees or less than 130 degrees or less than 120 degrees or less than 110 degrees or less than 100 degrees or less than 90 degrees or less than 80 degrees or less than 70 degrees or less than 60 degrees or less than 50 degrees or less than 40 degrees or less than 30 degrees.

Embodiment 8. The abrasive particle of Embodiment 7, wherein the central angle is at least 1 degree or at least 10 degrees or at least 20 degrees or at least 30 degrees or at least 40 degrees or at least 50 degrees or at least 60 degrees or at least 70 degrees.

Embodiment 9. The abrasive particle of Embodiment 1, wherein the body approximates a shape of a sphere sector.

Embodiment 10. The abrasive particle of Embodiment 1, wherein the body approximates a shape of an spherical wedge.

Embodiment 11. The abrasive particle of Embodiment 1, wherein the body is formed from a crushed sphere.

Embodiment 12. The abrasive particle of Embodiment 1, wherein the first surface approximates a shape of a portion of a sphere.

Embodiment 13. The abrasive particle of Embodiment 1, wherein the second surface comprises a fractured surface.

Embodiment 14. The abrasive particle of Embodiment 1, wherein the third surface comprises a fracture surface.

Embodiment 15. The abrasive particle of Embodiment 1, wherein the second surface has a greater surface roughness than the first surface.

Embodiment 16. The abrasive particle of Embodiment 1, wherein the third surface has a greater surface roughness than the first surface.

Embodiment 17. The abrasive particle of Embodiment 1, wherein the first edge and second edge terminate at a first exterior corner and join the first surface, second surface, and third surface.

Embodiment 18. The abrasive particle of Embodiment 1, wherein the body is not a shaped abrasive particle made by use of a production tool.

Embodiment 19. The abrasive particle of Embodiment 1, wherein the body is an abrasive particle that is formed absent molding, extruding, pressing, cutting or similar methods used to form shaped abrasive particles.

Embodiment 20. The abrasive particle of Embodiment 17, wherein the first edge and second edge further terminate at a second exterior corner opposite the first exterior corner.

Embodiment 21. The abrasive particle of Embodiment 1, further comprising a third edge joining the second surface and the third surface.

Embodiment 22. The abrasive particle of Embodiment 21, wherein third edge comprises a linear contour.

Embodiment 23. The abrasive particle of Embodiment 21, wherein the third edge comprises a more linear contour than the first edge.

Embodiment 24. The abrasive particle of Embodiment 21, wherein the third edge comprises a more linear contour than the second edge.

Embodiment 25. The abrasive particle of Embodiment 21, wherein the third edge terminates at a first exterior corner with the first edge and second edge.

Embodiment 26. The abrasive particle of Embodiment 25, wherein the third edge terminates at a second exterior corner opposite the first exterior corner.

Embodiment 27. The abrasive particle of Embodiment 1, further comprising at least one fractured corner region.

Embodiment 28. The abrasive particle of Embodiment 27, wherein the fractured corner region comprises less than 25% of the total surface area of the body or not greater than 20% or not greater than 15% or not greater than 10% or not greater than 8%.

Embodiment 29. The abrasive particle of Embodiment 1, further comprising a fourth surface opposite the first surface and between the second surface and the third surface.

Embodiment 30. The abrasive particle of Embodiment 29, further comprising a third edge joining the second surface and the fourth surface.

Embodiment 31. The abrasive particle of Embodiment 29, further comprising a fourth edge joining the third surface and the fourth surface.

Embodiment 32. A fixed abrasive article including the abrasive particle of Embodiment 1.

Embodiment 33. The abrasive particle of Embodiment 1, wherein the abrasive particle is used as a free abrasive in a material removal operation.

Embodiment 34. The abrasive particle of Embodiment 1, wherein the abrasive particle is formed by crushing sintered spheres.

Embodiment 35. The abrasive particle of Embodiment 1, wherein the abrasive particle comprises at least one abrasive characteristic that is at least 1% greater than a crushed-then-sintered particle, the abrasive characteristic including at least one of hardness, toughness, friability, tip sharpness, sharpness or any combination thereof.

Embodiment 36. The abrasive particle of Embodiment 1, wherein the body comprises a length, width and thickness, and wherein the body comprises a primary aspect ratio of at least 1:1 or at least 1.1:1 or at least 1.2:1 or at least 1.5:1 or at least 1.8:1 or at least 2:1 or at least 3:1 or at least 4:1 or at least 5:1 or at least 6:1 or at least 10:1.

Embodiment 37. The abrasive particle of Embodiment 1, wherein the body comprises a length, width and thickness, and wherein the body comprises a secondary aspect ratio of width:height of at least 1:1 or at least 1.1:1 or at least 1.2:1 or at least 1.5:1 or at least 1.8:1 or at least 2:1 or at least 3:1 or at least 4:1 or at least 5:1 or at least 8:1 or at least 10:1.

Embodiment 38. The abrasive particle of Embodiment 1, wherein the body comprises a length, width and thickness, and wherein the body comprises a tertiary aspect ratio of at least 1:1 or at least 1.1:1 or at least 1.2:1 or at least 1.5:1 or at least 1.8:1 or at least 2:1 or at least 3:1 or at least 4:1 or at least 5:1 or at least 8:1 or at least 10:1.

Embodiment 39. The abrasive particle of Embodiment 1, wherein the body comprises at least one of bauxite, mullite, hematite, anatase, and amorphous phase or any combination thereof.

Embodiment 40. The abrasive particle of Embodiment 1, wherein the body comprises nepheline syenite.

Embodiment 41. The abrasive particle of Embodiment 1, wherein a majority of the body is polycrystalline.

Embodiment 42. The abrasive particle of Embodiment 1, wherein the body comprises an oxide.

Embodiment 43. The abrasive particle of Embodiment 1, wherein the body comprises at least 40 wt % alumina for a total weight of the body or at least 50 wt % or at least 60 wt % or at least 70 wt % or at least 80 wt % alumina or at least 90 wt % alumina or at least 91 wt % alumina or at least 92 wt % alumina or at least 93 wt % alumina or at least 94 wt % alumina or at least 95 wt % alumina or at least 96 wt % alumina or at least 97 wt % alumina or at least 98 wt % alumina or at least 99 wt % alumina.

Embodiment 44. The abrasive particle of Embodiment 1, wherein the body comprises not greater than 99.5 wt % alumina or not greater than 99 wt % alumina or not greater than 98.5 wt % alumina or not greater than 97.5 wt % alumina or not greater than 97 wt % alumina or not greater than 96 wt % alumina or not greater than 94 wt % alumina.

Embodiment 45. The abrasive particle of Embodiment 1, wherein the body consists essentially of alumina.

Embodiment 46. The abrasive particle of Embodiment 1, wherein the body comprises at least 0.5 wt % silica for a total weight of the body or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 15 wt % or at least 18 wt %.

Embodiment 47. The abrasive particle of Embodiment 1, wherein the body comprises not greater than 50 wt % silica or not greater than 45 wt % or not greater than 40 wt % or not greater than 35 wt % or not greater than 30 wt % or not greater than 25 wt % or not greater than 20 wt % or not greater than 15 wt % or not greater than 12 wt % or not greater than 10 wt % or not greater than 9 wt % or not greater than 8 wt %.

Embodiment 48. The abrasive particle of Embodiment 1, wherein the body comprises at least 0.5 wt % iron oxide for a total weight of the body or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 15 wt % or at least 18 wt %.

Embodiment 49. The abrasive particle of Embodiment 1, wherein the body comprises not greater than 50 wt % iron oxide or not greater than 45 wt % or not greater than 40 wt % or not greater than 35 wt % or not greater than 30 wt % or not greater than 25 wt % or not greater than 20 wt % or not greater than 15 wt % or not greater than 12 wt % or not greater than 10 wt % or not greater than 9 wt % or not greater than 8 wt % or not greater than 5 wt % or not greater than 4 wt % or not greater than 3 wt %.

Embodiment 50. The abrasive particle of Embodiment 1, wherein the body comprises at least 0.5 wt % titanium oxide for a total weight of the body or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 15 wt % or at least 18 wt %.

Embodiment 51. The abrasive particle of Embodiment 1, wherein the body comprises not greater than 20 wt % titanium oxide or not greater than 18 wt % or not greater than 15 wt % or not greater than 12 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt %.

Embodiment 52. The abrasive particle of Embodiment 1, wherein the body comprises at least 1 wt % of a corundum phase for a total weight of the body or at least 5 wt % or at least 10 wt % or at least 15 wt % or at least 20 wt % or at least 30 wt % or at least 40 wt % or at least 50 wt % or at least 60 wt % or at least 70 wt % or at least 80 wt % or at least 90 wt % or at least 95 wt %.

Embodiment 53. The abrasive particle of Embodiment 1, wherein the body comprises not greater than 99 wt % of a corundum phase for a total weight of the body or not greater than 90 wt % or not greater than 80 wt % or not greater than 70 wt % or not greater than 60 wt % or not greater than 50 wt % or not greater than 40 wt % or not greater than 30 wt % or not greater than 20 wt % or not greater than 10 wt %.

Embodiment 54. The abrasive particle of Embodiment 1, wherein the body comprises at least 1 wt % of a mullite phase for a total weight of the body or at least 5 wt % or at least 10 wt % or at least 15 wt % or at least 20 wt % or at least 30 wt % or at least 40 wt % or at least 50 wt % or at least 60 wt % or at least 70 wt % or at least 80 wt % or at least 90 wt % or at least 95 wt %.

Embodiment 55. The abrasive particle of Embodiment 1, wherein the body comprises not greater than 99 wt % of a mullite phase for a total weight of the body or not greater than 90 wt % or not greater than 80 wt % or not greater than 70 wt % or not greater than 60 wt % or not greater than 50 wt % or not greater than 40 wt % or not greater than 30 wt % or not greater than 20 wt % or not greater than 10 wt %.

Embodiment 56. The abrasive particle of Embodiment 1, wherein the body consists essentially of corundum and mullite phases.

Embodiment 57. The abrasive particle of Embodiment 56, wherein the content of corundum is greater than the content of mullite.

Embodiment 58. The abrasive particle of Embodiment 56, wherein the content of mullite is greater than the content or corundum.

Embodiment 59. A plurality of abrasive particles, wherein at least 1% of the abrasive particles of the plurality of abrasive particles have a first shape, wherein the first shape includes a body including a first surface having a rounded contour, a second surface joined to the first surface at a first edge, the second surface having a less rounded contour than the first surface, and a third surface joined to the first surface at a second edge, the third surface having a less rounded contour than the first surface.

Embodiment 60. The plurality of abrasive particles of Embodiment 59, further comprising a loose pack density (g/cm3) of at least 1.2 or at least 1.3 or at least 1.4 or at least 1.5 or at least 1.6.

Embodiment 61. The plurality of abrasive particles of Embodiment 59, further comprising a loose pack density (g/cm3) of not greater than 2 or not greater than 1.9 or not greater than 1.8 or not greater than 1.7 or not greater than 1.6 or not greater than 1.5.

Embodiment 62. The plurality of abrasive particles of Embodiments 60 or 61, wherein the abrasive particulate has an average grit size within a range of 16 grit to not greater than 60 grit or within a range of at least 20 grit to not greater than 46 grit or within a range of at least 24 grit to not greater than 36 grit.

Embodiment 63. The plurality of abrasive particles of Embodiment 59, wherein at least 2% of the abrasive particles of the plurality of particles have the first shape or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% or at least 60% or at least 61% or at least 62% or at least 63% or at least 64% or at least 65% or at least 66% or at least 67% or at least 68% or at least 69% or at least 70% or at least 71% or at least 72% or at least 73% or at least 74% or at least 75% or at least 76% or at least 77% or at least 78% or at least 79% or at least 80% or at least 81% or at least 82% or at least 83% or at least 84% or at least 85% or at least 86% or at least 87% or at least 88% or at least 89% or at least 90% or at least 91% or at least 92% or at least 93% or at least 94% or at least 95% or at least 96% or at least 97% or at least 98% or at least 99%.

Embodiment 64. The plurality of abrasive particles of Embodiment 59, wherein not greater than 99% of the abrasive particles of the plurality of particles have the first shape or not greater than 98% or not greater than 97% or not greater than 96% or not greater than 95% or not greater than 94% or not greater than 93% or not greater than 92% or not greater than 91% or not greater than 90% or not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50% or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1%.

Embodiment 65. The plurality of abrasive particles of Embodiment 59, wherein the first shape comprises any of the features of Embodiments 2-58.

Embodiment 66. The plurality of abrasive particles of Embodiment 59, wherein at least 1% of the abrasive particles of the plurality of abrasive particles have at least one surface defining a portion of a sphere or at least 2% or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% or at least 60% or at least 61% or at least 62% or at least 63% or at least 64% or at least 65% or at least 66% or at least 67% or at least 68% or at least 69% or at least 70% or at least 71% or at least 72% or at least 73% or at least 74% or at least 75% or at least 76% or at least 77% or at least 78% or at least 79% or at least 80% or at least 81% or at least 82% or at least 83% or at least 84% or at least 85% or at least 86% or at least 87% or at least 88% or at least 89% or at least 90% or at least 91% or at least 92% or at least 93% or at least 94% or at least 95% or at least 96% or at least 97% or at least 98% or at least 99%.

Embodiment 67. The plurality of abrasive particles of Embodiment 59, wherein not greater than 99% of the abrasive particles of the plurality of particles have a body including at least one surface defining a portion of a sphere or not greater than 98% or not greater than 97% or not greater than 96% or not greater than 95% or not greater than 94% or not greater than 93% or not greater than 92% or not greater than 91% or not greater than 90% or not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50% or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1%.

Embodiment 68. The plurality of abrasive particles of Embodiment 59, further comprising a second shape defining a body having an angular shape.

Embodiment 69. The plurality of abrasive particles of Embodiment 68, wherein the angular shape is absent a major surface having a curvature defining a portion of a sphere.

Embodiment 70. The plurality of abrasive particles of Embodiment 68, wherein at least 1% of the abrasive particles of the plurality of abrasive particles have a body of the second shape or at least 2% or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% or at least 60% or at least 61% or at least 62% or at least 63% or at least 64% or at least 65% or at least 66% or at least 67% or at least 68% or at least 69% or at least 70% or at least 71% or at least 72% or at least 73% or at least 74% or at least 75% or at least 76% or at least 77% or at least 78% or at least 79% or at least 80% or at least 81% or at least 82% or at least 83% or at least 84% or at least 85% or at least 86% or at least 87% or at least 88% or at least 89% or at least 90% or at least 91% or at least 92% or at least 93% or at least 94% or at least 95% or at least 96% or at least 97% or at least 98% or at least 99%.

Embodiment 71. The plurality of abrasive particles of Embodiment 68, wherein not greater than 99% of the abrasive particles of the plurality of particles have a body having the second shape or not greater than 98% or not greater than 97% or not greater than 96% or not greater than 95% or not greater than 94% or not greater than 93% or not greater than 92% or not greater than 91% or not greater than 90% or not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50% or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1%.

Embodiment 72. A fixed abrasive article including the plurality of abrasive particles of Embodiment 59.

Embodiment 73. The plurality of abrasive particles of Embodiment 72, wherein the fixed abrasive is a bonded abrasive, coated abrasive, wire brush, or any combination thereof.

Embodiment 74. A method for forming a plurality of abrasive particles comprising:

comminuting a plurality of sintered particles to form a plurality of abrasive particles, wherein at least a portion of the sintered particles have a spherical shape solid prior to comminuting.

Embodiment 75. The method of Embodiment 74, wherein any particle of the plurality of particles or the plurality of abrasive particles have any features of the preceding Embodiments.

Embodiment 76. The method of Embodiment 74, further comprising forming a mixture comprising an aluminous material.

Embodiment 77. The method of Embodiment 74, wherein the aluminous material comprises bauxite.

Embodiment 78. The method of Embodiment 74, wherein the aluminous material comprises at least one of alumina, titanium oxide, silica, iron oxide or any combination thereof.

Embodiment 79. The method of Embodiment 74, wherein the aluminous material comprises a majority content of alumina.

Embodiment 80. The method of Embodiment 76, further comprising shaping the mixture to form a plurality of solid particles, wherein at least a portion of the solid particles have the spherical shape.

Embodiment 81. The method of Embodiment 80, wherein at least a portion includes a majority or at least 60% of the total solid particles or at least 70% or at least 80% or at least 90% or at least 99% or essentially all of the solid particles.

Embodiment 82. The method of Embodiment 74, wherein comminuting includes at least one of roll crushing, milling, explosion, or any combination thereof.

Embodiment 83. The method of Embodiment 74, wherein comminuting includes roller crushing.

Embodiment 84. The method of Embodiment 74, further comprising sorting and sieving the plurality of abrasive particles.

Embodiment 85. The method of Embodiment 74, wherein the plurality of abrasive particles have an average particle size of at least particles can have an average particle size, as measured by the largest dimension (i.e., length) of at least about 10 microns or at least 20 microns or at least 50 microns or at least 100 microns or at least about 150 microns or at least about 200 microns or at least about 300 microns or at least about 400 microns or at least about 500 microns or at least about 600 microns or at least about microns or at least about 800 microns or at least about 900 microns.

Embodiment 86. The method of Embodiment 74, wherein the plurality of abrasive particles have an average particle size of not greater than 5 mm or not greater than about 3 mm or not greater than about 2 mm or not greater than about 1.5 mm or not greater than 1 mm or not greater than 900 microns or not greater than 800 microns or not greater than 700 microns or not greater than 600 microns or not greater than 500 microns or not greater than 400 microns or not greater than 300 microns or not greater than 200 microns or not greater than 100 microns.

Embodiment 87. The method of Embodiment 74, wherein the body is an abrasive particle that is formed absent molding, extruding, pressing, cutting or similar methods used to form shaped abrasive particles.

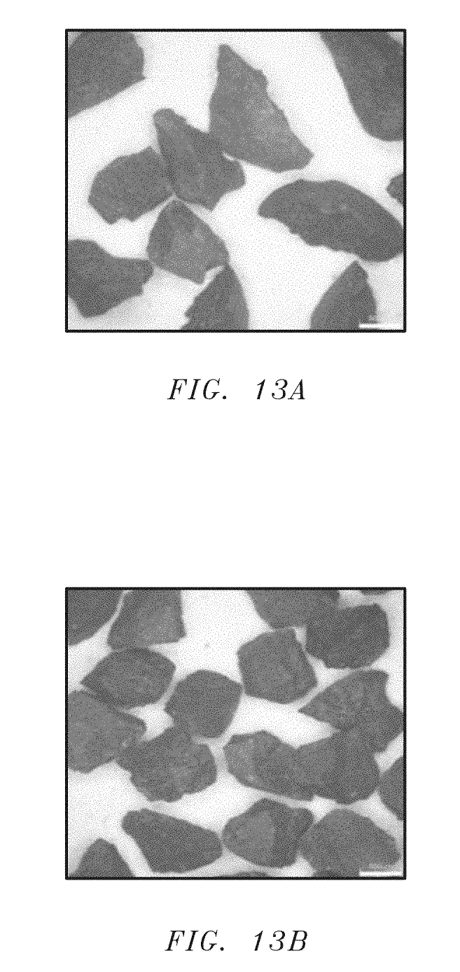

Embodiment 88. An abrasive particle having one or more features of any one of the abrasive particles depicted in FIGS. 2-24.

Embodiment 89. A plurality of abrasive particles having one or more features of the abrasive particles depicted in FIGS. 2-24.

Embodiment 90. A plurality of abrasive particles, comprising an average particle size of at least 300 microns and not greater than 900 microns, a specific surface area of at least 0.04 m2/g and not greater than 0.10 m2/g, a loose packed density (LPD) of at least 1.50 g/cm3 and not greater than 2.0 g/cm3, and an alumina content of at least 63 wt % based on a total weight of the plurality of particles.

Embodiment 91. The plurality of abrasive particles of Embodiment 90, wherein the alumina content is at least 65 wt % or at least 67 wt %, or at least 70 wt %, or at least 72 wt %, or at least 75 wt %.

Embodiment 92. The plurality of abrasive particles of Embodiment 90, wherein the specific surface area is at least 0.045 m2/g, or at least 0.050 m2/g, or at least 0.055 m2/g.

Embodiment 93. The plurality of abrasive particles of Embodiment 91, wherein the specific surface area is not greater than 0.095 m2/g, or not greater than 0.090 m2/g, or not greater than 0.085 m2/g.

Embodiment 94. The plurality of abrasive particles of Embodiment 90, wherein the average particle size is at least 350 microns, or at least 400 microns, or at least 450 microns, or at least 500 microns, or at least 550 microns.

Embodiment 95. The plurality of abrasive particles of Embodiment 90, wherein the average particle size is not greater than 850 microns, such as not greater than 800 microns, not greater than 750 microns, not greater than 700 microns, or not greater than 650 microns, or not greater than 600 microns.

Embodiment 96. The plurality of abrasive particles of Embodiment 90, wherein the LPD is at least 1.55 g/cm3.

Embodiment 97. The plurality of abrasive particles of Embodiment 90, wherein the LPD is not greater than 1.9 g/cm3, such as not greater than 1.85 g/cm3, not greater than 1.80 g/cm3, not greater than 1.75 g/cm3, or not greater than 1.70 g/cm3.

Embodiment 98. The plurality of abrasive particles of Embodiment 90, wherein a ball mill friability (BM-F) of the plurality of particles is not greater than 50%, the BM-F being the percentage loss of 100 g particles having an average size between 500 microns and 600 microns, and subjected to 8.0 minutes ball milling with a US Stoneware ball mill machine at 78-80 rpm.

Embodiment 99. The plurality of abrasive particles of Embodiment 90, wherein a high pulse oscillation friability (HPO-F) of the plurality of particles is not greater than 80%, the HPO-F being measured with 25 g of the plurality of particles having an average particle size between 500 microns and 600 microns with a high pulse oscillation crusher at 1450 rpm for 5 seconds, and wherein the HPO-F expresses a percentage of particle breakdown to a size lower than 425 microns.

Embodiment 100. The plurality of abrasive particles of Embodiment 90, wherein the plurality of particles includes at least 5% particles based on the total amount of particles having a shape of the particle of any of Embodiments 1 to 58.

Embodiment 101. The plurality of abrasive particles of any of Embodiments 59 to 71, wherein an average particle size of at least 300 microns and not greater than 900 microns, a specific surface area of at least 0.04 m2/g and not greater than 0.10 m2/g, a loose packed density (LPD) of at least 1.50 g/cm3 and not greater than 2.0 g/cm3, and an alumina content of at least 63 wt % based on a total weight of the plurality of particles

Embodiment 102. A method for forming a plurality of abrasive particles, comprising

forming a green granule mixture comprising an inorganic material, an organic binder and water, wherein the inorganic material comprises alumina in an amount of at least 60 wt % based on a total amount of the inorganic material and a particle size of the inorganic material is not greater than 25 microns;

sintering the green granules at a temperature of at least 1100° C. to form proppant particles;

crushing the proppant particles in a roller crusher to an average particle size of at least 100 microns and not greater than 2000 microns.

Embodiment 103. The method of Embodiment 102, wherein the inorganic material is bauxite.

Embodiment 104. The method of Embodiment 102, wherein sintering is conducted at a temperature of at least 1250° C.

Embodiment 105. The method of Embodiment 102, wherein crushing is conducted using a roller crusher and the proppant particles are crushed within a gap between opposite rotating rolls of the roller crusher.

Embodiment 106. The method of Embodiment 102, wherein the plurality of abrasive particles has a ball mill friability (BM-F) of not greater than 50%, the BM-F being the percentage loss of 100 g particles having an average size between 500 microns and 600 microns, and subjected to 8.0 minutes ball milling with a US Stoneware ball mill machine at 78-80 rpm.

Embodiment 107. The method of Embodiment 102, wherein a high pulse oscillation friability (HPO-F) of the plurality of particles is not greater than 80%, the HPO-F being measured with 25 g of the plurality of particles having an average particle size between 500 microns and 600 microns with a high pulse oscillation crusher at 1450 rpm for 5 seconds, and wherein the HPO-F expresses a percentage of particle breakdown to a size lower than 425 microns.

### EXAMPLES

### Example 1

Preparing of Spherical Proppant Particles.

Six different types of bauxite with different alumina content (between 60 wt % and 86 wt %) were subjected to crushing in a jaw crusher (Sturtevant 2×6) to obtain bauxite particles having an average particles size D50 of not greater than 2 mm. Thereafter, the bauxite particles were heated to a temperature of 500° C. to remove chemically and physically bounded water. After the water removal, the particles were ball milled to obtain a fine bauxite powder having a D90 size of not greater than 20 microns.

A granulation mixture was prepared combining the fine bauxite powder, a binder, and water, and the granulation was subjected to sintering at a temperature of 1250° C. Details of the procedure of making sintered round proppant particles can be found in U.S. Pat. No. 8,772,188, which is entirely incorporated by reference herein.

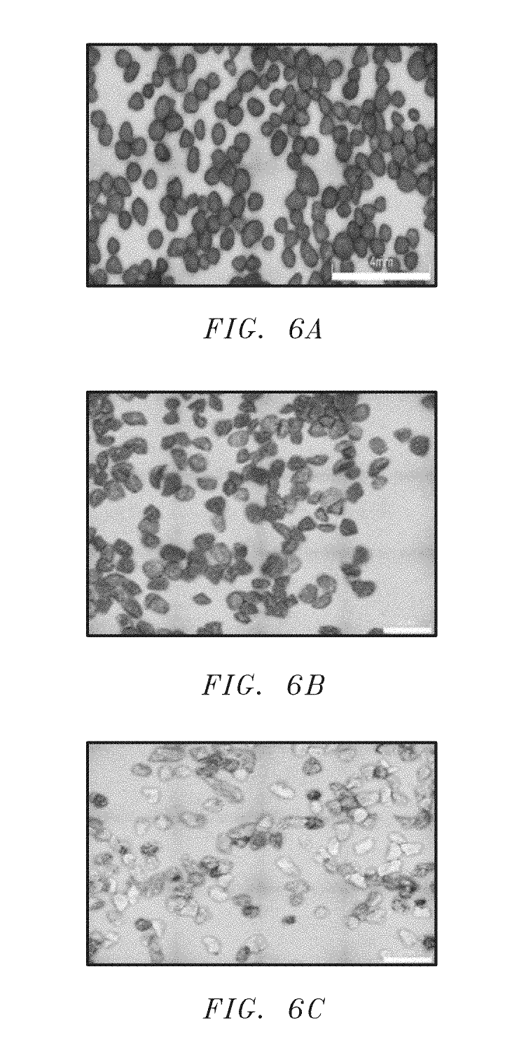

The obtained sintered material was a plurality of roundish shaped particles, hereinafter also called “round proppant particles,” although the shape of the particles was not perfectly spherical. An optical microscope image of the round proppant particles can be seen in FIG. 6A. One example of a size distribution of sintered round proppant particles is summarized in Table 1.

It will be appreciated that the size of the sintered round proppant particles can be larger or smaller than shown in Table 1, which is dependent from the making of the granulation mixture before sintering, as also described in U.S. Pat. No. 8,772,188.

TABLE 1

| Sieve | Sieve opening | Amount retained | Amount retained |
|---|---|---|---|
| number* | size [μm] | on sieve [g] | on sieve [%] |
| +12 | >1680 | 3.13 | 0.79% |
| 12/14 | 1680-1410 | 152.04 | 38.40% |
| 14/16 | 1410-1190 | 175.2 | 44.25% |
| 16/18 | 1190-1000 | 20.09 | 5.07% |
| 18/20 | 1000-841 | 7.2 | 1.82% |
| 20/30 | 841-595 | 22.25 | 5.62% |
| 30/35 | 595-500 | 9.69 | 2.45% |
| −35 | <500 | 6.33 | 1.60% |
| | | 395.93 | 100.00% |

*The sieve numbers relate to the definitions according ANSI B74.12-2001.

### Example 2

Preparing of Crushed Proppant Particles having a 24 Grit Size.

The sintered particles obtained in Example 1 were screened to remove the particles that can pass an 18 mesh screen (which corresponds to the particle fraction smaller than 1000 microns). The particle fraction greater than 1000 microns (−18 mesh) was roll crushed in a first crushing procedure using a roll crusher Sturtevant Modell 8×5 with a funnel gap of ¾ inch and a speed setting 4 at 1500 g/min with rolls at 218 rpm on an 8 inches diameter roll, with a gap of 0.035 inches (0.889 mm).

The crushed material was screened with a SWECO screener LS18 53383, using a four sieve setup with sieve sizes 20, 25, 30, and 35. A top pan was used to center the incoming material. The SWECO screener weight setting was at 120° (4 screens and 5 rings). The crushed material from the 20/25 sieves (707 μm-840 μm) was retained, and the fines (fraction smaller than about 707 μm) were also separated and retained.

Thereafter, a second crushing with the Sturtevant roll crusher was conducted with the 18/20 sieve fraction of Table 1, using a speed setting of 7, which is 2537 g/min at 218 rpm with a ¾ inches funnel gap and rolls at 8 inches diameter at approximately 218 rpm with a rolls gap of 0.020 inches. The material obtained from the second crushing was also SWECO screened on 20, 25, 30, 35 screens. The 20/25 mesh size materials (710 μm-841 μm fraction) from the first and second crush passes were blended together and are described hereinafter as 24 grit samples.

A representative example of the crushed proppant particles is shown in Table 2, wherein different particle size fractions were quantified using a Rotap screener with a sieve number combination of 18, 20, 30, 35.

TABLE 2

| Sieve | Sieve opening | Amount of particles |
|---|---|---|
| combination | size [μm]] | [wt %] |
| 16/18 | 1000-1190 | 0 |
| 18/20 | 1000-841 | 7.07% |
| 20/25 | 841-707 | 55.15% |
| 25/30 | 707-595 | 28.42% |
| 30/35 | 595-500 | 8.45% |
| −35 | <500 | 0.92% |
| total | | 100.00% |

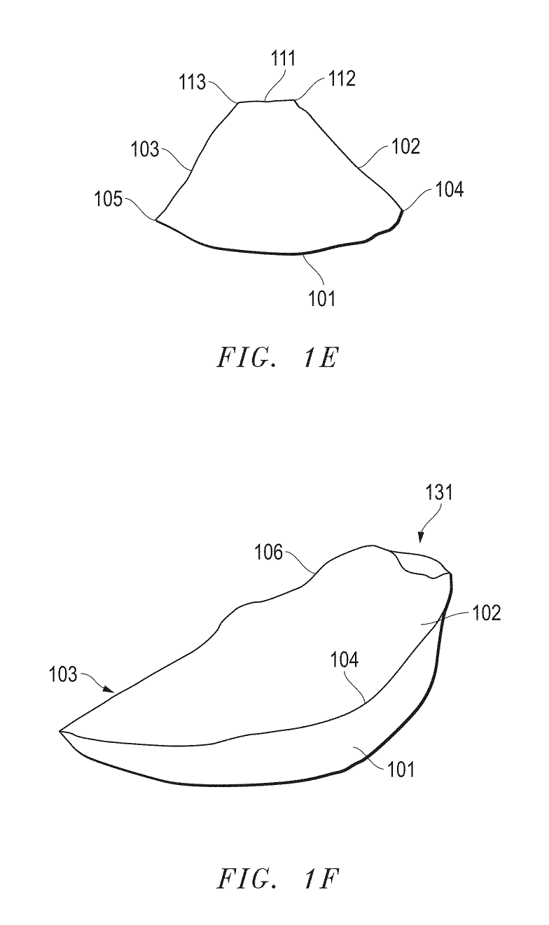

Optical microscope images of the crushed proppant particles of an above described 24 grit size particle batches can be seen in FIG. 2 and FIG. 3 (same sample view at different magnification).

To prepare a 36 grit size batch of crushed proppant particles, a 12/18 feed stock fraction of sintered round proppant particles was used. The round proppant material was fed at a rate of about 720 g/min into the Sturtevant roll crusher model 8×5, having gap setting at 0.025 inches to 0.035 inches. Thereafter, the grains are screened to obtain the desired 36 grit fraction. Any oversized material was subjected again to crushing by the same process and screened, and the 36 grit fraction combined with the 36 grit grains of the first run.

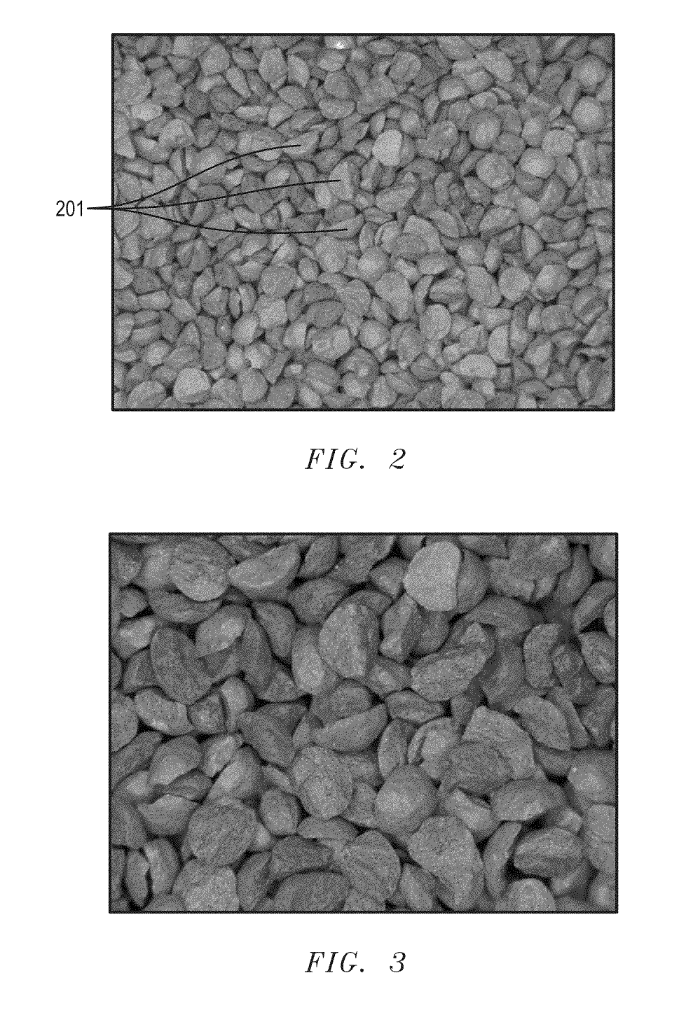

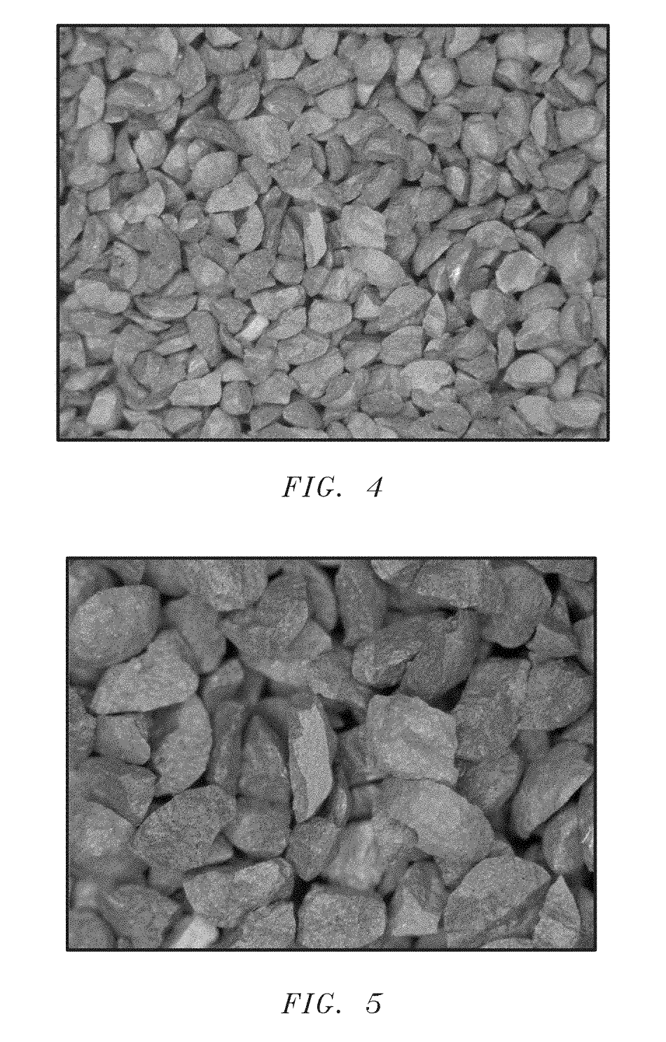

Representative optical microscope images of the crushed proppant particles of the above described 36 grit size particle batch can be seen in FIG. 4 and FIG. 5 (same sample view at different magnification).

It can be seen from the images of FIGS. 2-5 that a certain portion of the particles have the shape of a partial sphere or a spherical wedge (like orange slices).

### Comparative Example 3

Preparing of Angular Particles.

Six different types of bauxite with varying alumina content (between 60 wt % and 86 wt %), as also used in Example 1, were subjected to crushing in a jaw crusher (Sturtevant 2×6) to obtain bauxite particles having a particles size in a range of about 0.5 mm to 2 mm. Thereafter, the bauxite particles were heated to a temperature of 500° C. to remove chemically and physically bounded water. After the water removal, the particles were sintered at a temperature of about 1300° C.

After the sintering, the particles were subjected to crushing using the same roll crusher and screening process as describe in Example 2 for making 36 grit size particle batches. The batch of 36 grit angular particles complied with ANSI B74.12-2001 requirements, and was used for the grinding tests further described below.

An example of an optical microscope image of angular particles with a 36 grit size is shown in FIG. 6C (see sample C16, Table 3), which is compared with an image of crushed proppant particles FIG. 6B (sample S4) and an image of round proppant particles FIG. 6A (sample C10). The particles of images 6A, 6B, and 6C have the same alumina content of about 75-76 wt %. It can be seen that the particles of FIG. 6C have highly irregular surfaces with many angles, which is the reason that these particles are called herein angular particles. No particles having the shape of a spherical wedge could be observed in the images taken for the angular shaped particles.

### Example 4

Friability Comparison.

The friability under stress of the crushed proppant particles of Example 2, the round proppant particles of Example 1, and the angular particles of Example 3 was compared conducting two different friability tests: 1) a ball mill test and 2) a high pulse oscillation test.

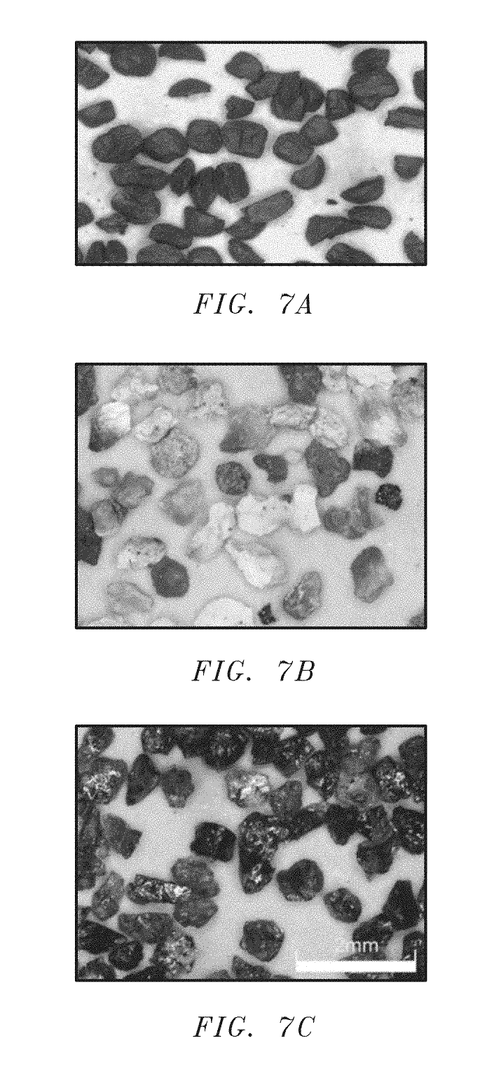

A further material used as standard comparison for the friability tests was brown fused alpha alumina particles (BFA) from Saint-Gobain. BFA is known for having suitable grinding properties with an acceptable friability (break down under stress) and is implemented in a large variety of commercial abrasive articles. An optical microscope image of the used BFA particles is shown in FIG. 7C, and compared with crushed proppant particles FIG. 7A (sample S5, Table 3) and angular particles FIG. 7C (sample C17).

All friability tests were conducted with 36 grit size particle samples. Table 3 provides a summary of the tested samples. Next to the ball mill friability (BM-F), Table 3 further includes the measured specific surface area, loose pack density (LPD) density, and Helium (He) density of the particle batches.

It can be seen from Table 3, that sintered crushed proppant particles with an alumina content of 68.14% or higher (see samples 2 to 5) surprisingly had a lower ball-mill friability (percentage breakdown under stress) than the brown fused alumina (BFA) particles (sample C1). It can be further seen from Table 3 that the angular particles (made according to Comparative Example 3) had a much higher ball mill friability than the BFA particles and the crushed proppant particles.

TABLE 3

| | | Alumina | | | | BM-Friability: |
|---|---|---|---|---|---|---|
| | | content | SSA | LPD | He density | breakdown |
| Sample # | Material | [wt %] | [m²/g] | [g/cm³] | [g/cm³] | [%] |
| C1 | Brown fused alumina | 95.4 | 0.009 | 1.88 | 3.96 | 55 |
| | (BFA) | | | | | |
| S2 | Crushed proppant | 80.5 | 0.055 | 1.67 | 3.45 | 34 |
| S3 | Crushed proppant | 75.28 | 0.061 | 1.64 | 3.45 | 41 |
| S4 | Crushed proppant | 75.4 | 0.075 | 1.57 | 3.26 | 41 |
| S5 | Crushed proppant | 68.14 | 0.067 | 1.55 | 3.26 | 48 |
| S6 | Crushed proppant | 61.7 | — | 1.38 | 2.98 | 59 |
| S7 | Crushed proppant | 60.81 | 0.085 | 1.35 | 2.95 | 68 |
| C8 | Spherical proppant | 80.8 | 0.002 | 1.91 | 3.42 | 35 |
| C9 | Spherical proppant | 75.28 | 0.036 | 1.93 | 3.37 | 40 |
| C10 | Spherical proppant | 76.40 | 0.007 | 1.80 | 3.24 | 42 |
| C11 | Spherical proppant | 68.36 | 0.020 | 1.80 | 3.16 | 53 |
| C12 | Spherical proppant | 68.20 | 0.012 | 1.54 | 2.88 | 44 |
| C13 | Spherical proppant | 55.05 | 0.127 | 1.52 | 2.80 | 71 |
| C14 | Angular bauxite | 85.2 | 0.077 | 1.35 | 3.51 | 61 |
| C15 | Angular bauxite | 75.62 | 0.190 | 1.24 | 3.47 | 95 |
| C16 | Angular bauxite | 76.9 | 0.273 | 1.20 | 3.30 | 83 |
| C17 | Angular bauxite | 72.96 | 0.117 | 1.26 | 3.44 | 86 |
| C18 | Angular bauxite | 72.8 | 0.102 | 1.33 | 3.31 | 71 |
| C19 | Angular bauxite | 60.37 | 0.286 | 1.39 | 2.98 | 88 |

Data of the measured high pulse oscillation friability (HPO-F) are show in Table 4. It can be seen that also under high pulse oscillation stress the crushed proppant particles with an alumina content of 68wt % and greater are less friable than the BFA particles used as comparison.

TABLE 4

| | | Alumina | HPO-F: |
|---|---|---|---|
| | | content | breakdown |
| Sample # | Material | [wt %] | [%] |
| C1 | Brown fused alumina (BFA) | 95.4 | 88.37 |
| S2 | Crushed proppant | 80.5 | 68.97 |
| S3 | Crushed proppant | 75.28 | 73.14 |
| S4 | Crushed proppant | 75.4 | 75.11 |
| S5 | Crushed proppant | 68.14 | 77.61 |
| S6 | Crushed proppant | 61.7 | 81.77 |
| S7 | Crushed proppant | 60.81 | 83.83 |
| C14 | Angular bauxite | 85.2 | 80.48 |
| C15 | Angular bauxite | 75.62 | 95.84 |
| C16 | Angular bauxite | 76.9 | 89.85 |
| C17 | Angular bauxite | 72.96 | 92.03 |
| C18 | Angular bauxite | 72.8 | 85.98 |
| C19 | Angular bauxite | 60.37 | 94.25 |

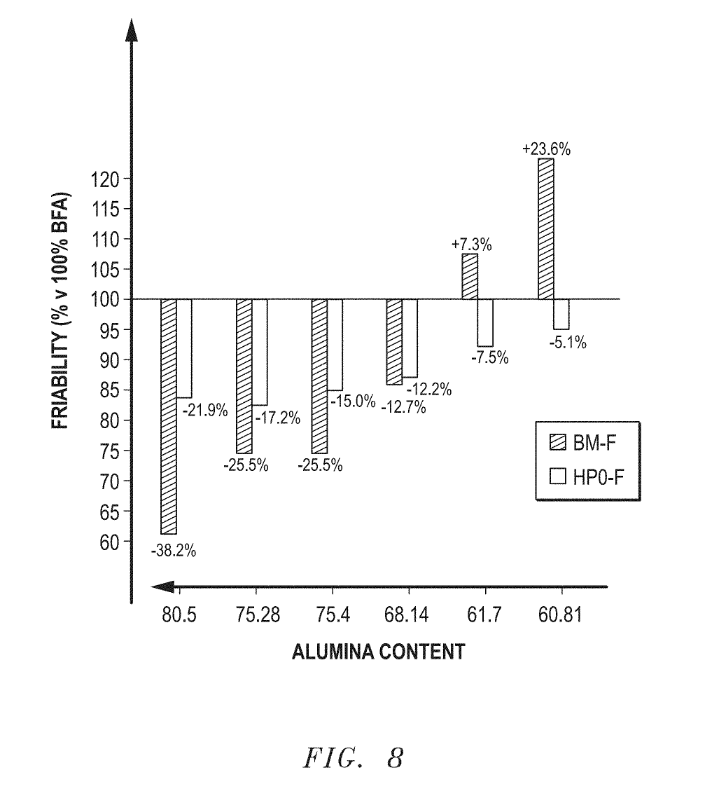

A direct comparison of the crushed proppant particles of the present disclosure in comparison to the friability of brown fused alumina (BFA) particles, both BM-friability and HPO-friability, is further shown if FIG. 8. The friability values measured for the BFA particles were set to 100% and the percentage decrease or increase in particle break down of the crushed proppant particles and the angular particles in comparison to the 100% BFA value illustrated. It can be seen that crushed proppant particles having an alumina content of 68.1 wt % and higher are stronger and less friable (less subjected to break down) than the brown fused alumina (BFA) particles. The friability advantage (stronger resistance against stress) of the crushed proppant particles in comparison to BFA particles can be seen especially when conducting the BM-friability test, wherein the crushed proppant particles had 12 to 38% less particle break down in comparison to the BFA particles.

Testing of the Ball Mill Friability (BM-F):

For the ball mill friability testing, each sample was screened on a Rotap screener RX29 using a 30/36 mesh sieve combination to insure that the particles were in a range of 500 μm to 600 μm.

100 g of the Rotap screened sample was added to the canister of a US Stoneware ball mill CZ99009 and subjected to ball milling for 8.0 minutes at a tachometer speed of 78-80 rpm. The balls of the ball mill are made of tungsten carbide and have a ¾ inch diameter size.

After the ball milling, the milled grains were removed from the canister and the balls, and subjected to 5 minutes screening with a Rotap screener using a sieve combination 30/36. Thereafter, the weight of the particles remaining on the 36 mesh sieve (>500 μm) of the Rotap screener was measured, and the percent weight loss (based on 100 g of starting sample) was calculated, which is expressed herein as ball mill friability in percent. Each test was repeated two times, and an average value was calculated.

Testing of the High Pulse Oscillation Friability (HPO-F):

For the HPO friability testing, each sample was sized with a Rotap screener RX29 that it had a particle size range between +480 μm and −600 μm, the main size range for 36 grit particle batches.

25 g of the sized grains were introduced into an oscillating crusher (CB2200 from SODEMI).

After the 5 seconds crushing, the crushed grains were removed from the oscillation crusher, and screened with a screening machine (LAB O-MODERNE vibration device) using a set of small sieves (80 mm diameter) for 5 minutes. The sieves had the following sizes: T1: 500 μm; T2: 425 μm; T3: 300 μm; T4: 150 μm, T5: 75 μm, and pan.

The fractions remaining on each sieve were weighed and the portion passing the T1 and T2 sieve (<425 μm) was calculated and expressed in percent of breakdown of the grains, which corresponds to the sum of the T3, T4, T5, and pan fractions.

The high pulse oscillation (HPO) friability was calculated as the percent amount of sample breakdown that is smaller than the combined T1 and T2 fraction based on the total amount of the starting sample. It was calculated according to the following equation:

HPO friability=[(total amount of sample)−(T1+T2)/total amount of sample]×100%

The HPO friability of each sample was tested twice, and an average value was calculated.

### Example 5

Single Layer Test (SLT) comparing grinding performance.

The grinding performance of the sintered crushed proppant particles of Example 2 was compared with the grinding performance of 1) brown fused alumina particles (BFA) from Saint-Gobain; 2) the spherical proppant particles of Example 1; and 3) with angular particles of comparative Example 3.

For the SLT testing, all tested particulate materials had an average particle size of 36 grits. Abrasive wheels were prepared by placing a single layer of abrasive particles on the outer diameter of a metal disc. The single layer wheel was attached to a 8-20 Okamoto grinder. As test piece was selected a 1018 carbon steel plate, and a grinding depth of 1.5 mils. The grinding testing machine registered the required peak power during grinding with increasing time, until the single grinding layer of the wheel had been depleted.

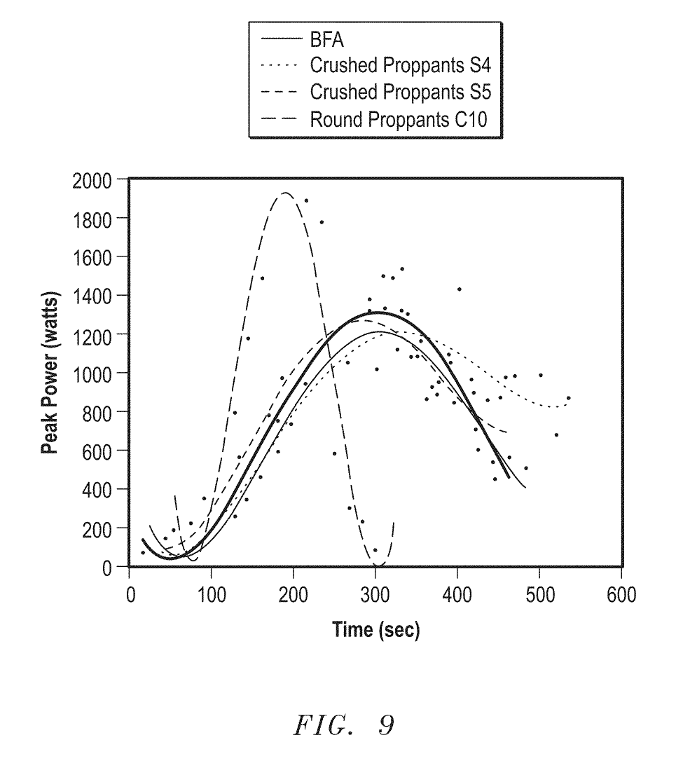

As can be seen in FIG. 9, single layer wheels with a single layer of spherical proppant particles did cut with a higher power and had a shorter life time than a single layer wheels with crushed proppant particles or wheels with brown fused alumina particles. It can be further seen that wheels made with crushed proppant particles had a very similar grinding performance as wheels made with brown fused alumina particles.

The similar grinding performance of the wheels containing crushed proppant particles in comparison to wheel containing BFA particles was a surprising observation, since the crushed proppant particles have a lower density and a lower alpha alumina content than the brown fused alumina particles. Not being bound to theory, this can be an indication that the shape of the particles obtained after sintering and crushing of the spherical proppant particles has a important influence on the grinding performance.

### Example 6

Particle Analysis.

Crushed proppant particle batches of different grit sizes (20, 24, 30, 36, 46, and 60) were made from round proppant particles having an alumina content of 68.36 wt %.

Of each batch, representative optical microscope images were made and analyzed with regard to the total amounts of particles per image and the amount of particles having the shape of a spherical wedge.

An example of a 16 grit sample used for quantifying the amount of spherical wedges within a particle batch can be seen at FIG. 9. The image analysis counted 59 grains shown in the image, of which were 26 grains considered as having the shape of a spherical wedge as defined in the present disclosure, which corresponds to a percent amount of 44% particles having a spherical wedge shape per batch.

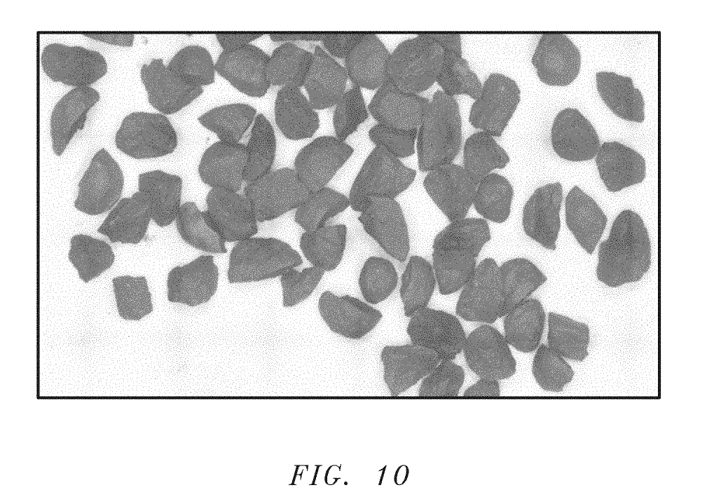

Similar quantifications were made on representative images for batches of the other grit sizes. A summary of the results are illustrated in Table 5 and FIG. 10.

It can be seen that with increasing grit size (which corresponds to decreasing particle size), the amount of particles having the shape of a spherical wedge decreases. At a size of 60 grit, no particle having the shape of a spherical wedge could be identified.

TABLE 5

| | | Amount of particles | % of spherical |
|---|---|---|---|
| Grit | Total amount of | with spherical wedge | wedge shaped |
| size | particles per image | shape per image | particles |
| 16 | 69 | 26 | 44 |
| 20 | 55 | 10 | 18 |
| 24 | 72 | 17 | 24 |
| 30 | 84 | 20 | 24 |
| 36 | 74 | 15 | 20 |
| 46 | 69 | 9 | 13 |
| 60 | 83 | 0 | 0 |

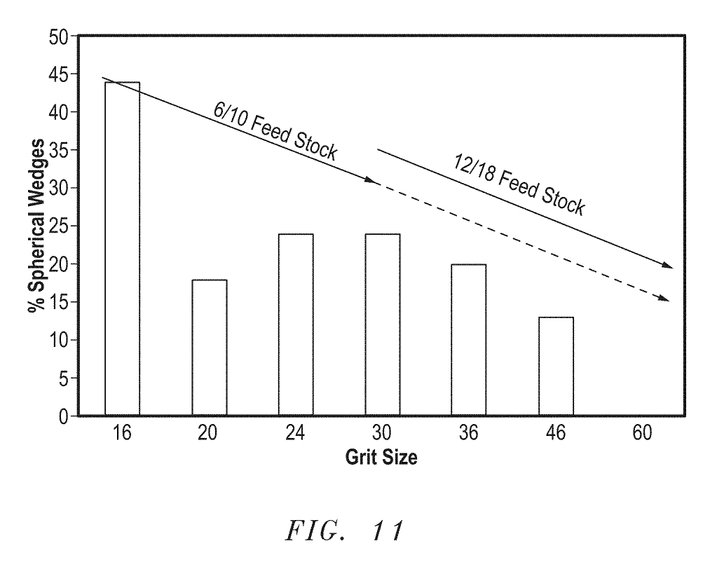

The crushed proppant particles of the present disclosure were further analyzed by measuring a sphericity value with a Retch Camsizer Ser#0596. For the measurements, crushed proppant particles having an alumina content of 68.14 wt % were prepared by roller crushing and sieving of different size ranges. An illustration of the results can be seen in FIG. 11. Each particle size range shown on the x-axis of FIG. 11 was a different measurement. The Camsizer measured the sphericity for each particle throughout the particle distribution of the test sample, and the sphericity value having the most amount of particles per tested sample was used as measuring point for the line drawings in FIG. 11. Each type of investigated particles (crushed proppants, round proppants and angular particles) had a different maxima of the sphericity value in dependency to the particle size of the batches. The following are the numbers for each maxima: a) crushed proppants: 28% of the particles of the 20/25 batch with a sphericity of 0.86; b) round proppants: 40% of the particles of a 35/40 batch with a sphericity of 0.931; and c) angular grains: 46% of the particles of a 30/35 batch with a sphericity of 0.83.

### Example 7

Comparison of Different Crushing Treatments.

A comparison was made by crushing round proppant particles of Example 1 using 1) a roller crusher having counter-rotating drum type rolls (Sturtevant roller crusher), wherein the gap between the rolls determines the crushing size; and 2) a pin wheel crusher (Simpactor), wherein the speed of the wheel rotation (rpm number) and the pin locations determine the crushing size.

For both crushing treatments, a mixture of round proppant particles was prepared as described in Example 1, having a mesh size in the range of 6/10 and 12/18 and an alumina content of 75.4wt %.

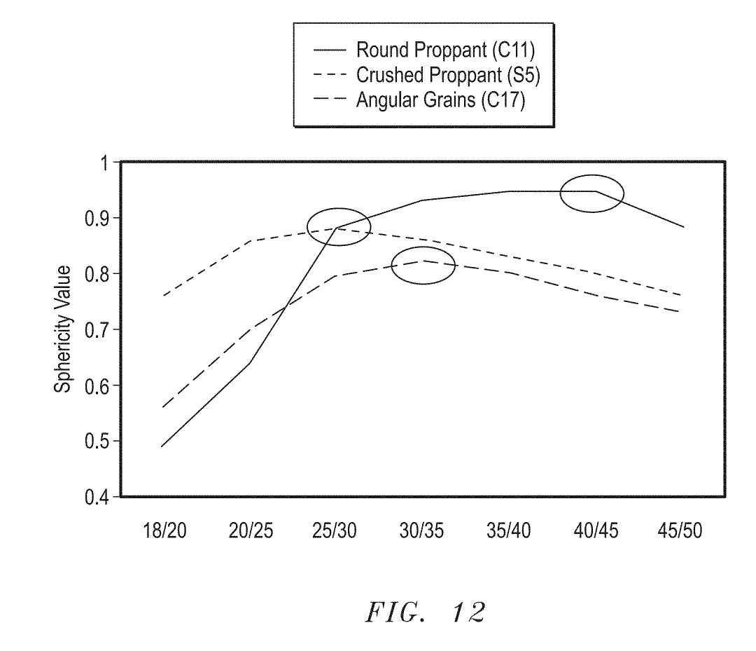

It could be observed that crushing the round proppant particles with different machines lead to particles of different particle size distribution and of different shape. While crushing with the roll crusher produced batches of crushed proppant particles which contain to a large content particles having the shape of spherical wedges (see FIG. 12A), the high impact pin wheel crusher (Simpactor) produced particles having a more blocky shape (see FIG. 12B) and did not include the shape pf spherical wedges. FIGS. 12A and 12B both illustrate particles taken from 20/25 mesh sieved badges.

It was further observed that with decreasing size of the crushed proppant particles, the amount of spherical wedges declined, and in the 60/70 mesh range (particles below 100 m) no particles having the shape of a spherical wedge could be identified, although a higher aspect ratio of length to width was maintained in comparison to the particles crushed with the Simpactor machine.

### Example 8

Measurement of Chemical and Mechanical Properties.

A chemical analysis of each sample shown in Table 3, analyzed by the content of Al₂O₃, SiO₂, Fe₂O₃, TiO₂ in wt % based on the total amount of the sample, as well as the percent amount of corundum phase and mullite phase is further summarized in Table 6.

TABLE 6

| | | | | | | Corundum phase | Mullite phase |
|---|---|---|---|---|---|---|---|
| Sample | Material | Al2O3 | SiO2 | Fe2O3 | TiO2 | [%] | [%] |
| S2 | Crushed proppant | 80.5 | 6.98 | 6.82 | 3.43 | 82.3 | |
| S3 | Crushed proppant | 75.28 | 8.36 | 11.26 | 3.25 | 56.4 | 21.7 |
| S4 | Crushed proppant | 75.4 | 13.9 | 3.86 | 3.34 | 71.6 | 5.8 |
| S5 | Crushed proppant | 68.14 | 15 | 11.63 | 3.48 | 29.5 | 46.6 |
| S6 | Crushed proppant | 61.7 | 25.36 | 5.63 | 2.58 | 50.2 | 17 |
| S7 | Crushed proppant | 60.81 | 25.27 | 7.06 | 2.98 | 20.7 | 52.5 |
| C8 | Spherical proppant | 80.8 | 7.22 | 6.27 | 3.41 | 80.9 | |
| C9 | Spherical proppant | 75.28 | 9.84 | 9.56 | 3.49 | 54.4 | 26.4 |
| C10 | Spherical proppant | 76.40 | 11.53 | 6.36 | 3.18 | 75.7 | 3.4 |
| C11 | Spherical proppant | 68.36 | 15.43 | 11.15 | 3.24 | 30.1 | 51.7 |
| C12 | Spherical proppant | 68.20 | 19.75 | 5.26 | 3.07 | 64.2 | 13.9 |
| C13 | Spherical proppant | 55.05 | 33.23 | 4.37 | 2.66 | 11.5 | 46.3 |
| C14 | Angular bauxite | 85.2 | 8.51 | 1.23 | 3.45 | 83.7 | 1.6 |
| C15 | Angular bauxite | 75.62 | 14.14 | 4.74 | 3.78 | 37.8 | 40.3 |
| C16 | Angular bauxite | 76.9 | 9.89 | 7.21 | 3.53 | 73.3 | 5.4 |
| C17 | Angular bauxite | 72.96 | 14.8 | 7.37 | 3.03 | 32.9 | 44.3 |
| C18 | Angular bauxite | 72.8 | 12.83 | 7.75 | 3.16 | 64.9 | 9.1 |
| C19 | Angular bauxite | 60.37 | 32.74 | 2.37 | 2.88 | 11.5 | 62.5 |

Measurement of the Specific Surface Area

The specific surface area for all tested samples was measured by conducting the BET (Brunauer, Emmett and Teller) method, using a Gemini VII instrument from Micromeritics.

Measurement of the He Density

The He density of the particles was measured with an Accupyc 1330 gas pycnometer from micrometrics.

Measurement of the Loose Pack Density (LPD)

The loose pack density, also called bulk density, was measured according to ANSI B74.4-1992.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. An abrasive particle including a body including a first surface having a rounded contour, a second surface joined to the first surface at a first edge, the second surface having a less rounded contour than the first surface, and a third surface joined to the first surface at a second edge, the third surface having a less rounded contour than the first surface.

2. The abrasive particle of claim 1, wherein the second surface and third surface are angled with respect to each other and define a central angle less than 180 degrees and at least 1 degree.

3. The abrasive particle of claim 1, wherein the body approximates a shape of an spherical wedge.

4. The abrasive particle of claim 1, wherein the body is formed from a crushed sphere.

5. The abrasive particle of claim 1, further comprising a third edge joining the second surface and the third surface.

6. The abrasive particle of claim 1, wherein the abrasive particle is formed by crushing sintered spheres.

7. The abrasive particle of claim 1, wherein the body comprises bauxite.

8. A plurality of abrasive particles, wherein at least 1% of the abrasive particles of the plurality of abrasive particles have a first shape, wherein the first shape includes a body including a first surface having a rounded contour, a second surface joined to the first surface at a first edge, the second surface having a less rounded contour than the first surface, and a third surface joined to the first surface at a second edge, the third surface having a less rounded contour than the first surface.

9. The plurality of abrasive particles of claim 8, wherein at least 10% of the abrasive particles of the plurality of particles have the first shape.

10. A loose abrasive comprising the plurality of abrasive particles of claim 8.

11. A fixed abrasive article including the plurality of abrasive particles of claim 8.

12. The plurality of abrasive particles of claim 9, further comprising an average particle size of at least 300 microns and not greater than 900 microns, a specific surface area of at least 0.04 m²/g and not greater than 0.10 m²/g, a loose packed density (LPD) of at least 1.50 g/cm³ and not greater than 2.0 g/cm³, and an alumina content of at least 63 wt % based on a total weight of the plurality of particles.

13. The plurality of abrasive particles of claim 12, wherein a ball mill friability (BM-F) of the plurality of particles is not greater than 50%, the BM-F being the percentage loss of 100 g particles having an average size between 500 microns and 600 microns, and subjected to 8.0 minutes ball milling with a US Stoneware ball mill machine at 78-80 rpm.

14. The plurality of abrasive particles of claim 12, wherein a high pulse oscillation friability (HPO-F) of the plurality of particles is not greater than 80%, the HPO-F being measured with 25 g of the plurality of particles having an average particle size between 500 microns and 600 microns with a high pulse oscillation crusher at 1450 rpm for 5 seconds, and wherein the HPO-F expresses a percentage of particle breakdown to a size lower than 425 microns.

15. A method for forming a plurality of abrasive particles, comprising forming a green granule mixture comprising an inorganic material, an organic binder and water, wherein the inorganic material comprises alumina in an amount of at least 60 wt % based on a total amount of the inorganic material and a particle size of the inorganic material is not greater than 25 microns;
sintereing the green granules at a temperature of at least 1100° C. to form proppant particles;
crushing the proppant particles in a roller crusher to an average particle size of at least 100 microns and not greater than 2000 microns.

16. The method of claim 15, wherein the inorganic material is bauxite.

17. The method of claim 15, wherein sintering is conducted at a temperature of at least 1250° C.

18. The method of claim 15, wherein crushing is conducted using a roller crusher and the proppant particles are crushed within a gap between opposite rotating rolls or the roller crusher.

19. The method of claim 15, wherein an the plurality of abrasive particle have an average particle size of at least 300 microns and not greater than 900 microns, a specific surface area of at least 0.04 m²/g and not greater than 0.10 m²/g, a loose packed density (LPD) of at least 1.50 g/cm³ and not greater than 2.0 g/cm³.

20. The method of claim 15, wherein at least 10% of the plurality of particles has a first shape, wherein the first shape includes a body including a first surface having a rounded contour, a second surface joined to the first surface at a first edge, the second surface having a less rounded contour than the first surface, and a third surface joined to the first surface at a second edge, the third surface having a less rounded contour than the first surface.
